(19) United States
(12) Patent Application Publication
(10) Pub. No.: US 2007/0014082 A1
(43) Pub. Date: Jan. 18, 2007

(54) Monitor with pivot

(75) Inventors: Beniz Wang, Banciao City (TW); Tien-Ming Chan, Taipei City (TW)

Correspondence Address: Genus Law Group PLLC;Raymond J. Ho; David B. Dort, Box 26219, Crystal City Station, Arlington, VA, 22215, US

(73) Assignee: Inventec Corporation

(21) Appl. No.: 11/181,703

(22) Filed: Jul. 13, 2005

(51) Int. Cl. G06F 1/16

(52) U.S. Cl. 361/681; 361/683

(57) ABSTRACT

A monitor capable of rotating on a pivot includes a display, a base and a connecting member. The base includes several control elements. The display is pivotally mounted on the base for turning to suitable viewing angles for user. The connecting member, having an internal space for wiring, connects the display and the base at eccentric positions. The connecting member further includes a first pivot, a second pivot and a pin. The first pivot connects to the display for pivoting the display in a Y-Z plane. The second pivot connects to the base for pivoting the connecting member in an X-Y plane. The pin connects the first pivot and the second pivot for pivoting the two pivots in an X-Z plane. The display and the control elements do not overlap each other.

### BACKGROUND OF THE INVENTION

1. Field of the Invention

The invention generally relates to a monitor, and in particular relates to a monitor having a pivot for rotation.

2. Description of the Related Art

Modern technologies advance fast. Many new electronic products, especially computers, are developed and brought into daily lives of people. Whatever a desktop or a notebook computer being used, a monitor is the necessary device for the user to check the input and output of the computer.

As monitors being so important, manufacturers put much effort on the functions and designs of monitors and try to improve their competitive power and get more sales. An example is a monitor capable of rotation in 90 degrees for being used in different positions.

FIGS. 1A, 1B, and 1C illustrate a conventional monitor with a pivot mechanism. The monitor 1 includes a display 10 pivotally connected via a pivot 100 to a base 12. The base 12 includes an electronic unit 120, such as an optical disc driver, and several control elements 122. However, when the display 10 being turned to the vertical position, the bottom of the display 10 is so close to the electronic unit 120 and the control elements 122, or even hinders them, so that the user is difficult to operate the electronic unit 120 (such as operating the optical disc driver) and the control elements 122 (such as adjusting the brightness of the display).

Therefore, the inventor elaborates to invent a monitor having a pivot for rotation, while free from the aforesaid problem.

### SUMMARY OF THE INVENTION

The object of the invention is to provide a monitor having a pivot for rotation. The pivot is eccentrically settled so that the monitor will not hinder the elements at the base.

A monitor according to the invention includes a display, a base and a connecting member. The base includes several control elements. The display is pivotally mounted on the base and can be turning to suitable viewing angles for user. The connecting member has a space and connects the display and the base at eccentric positions misaligned from geometrical centers of the display or the base.

The connecting member further includes a first pivot, a second pivot and a pin. The first pivot connects to the display and is able to pivot in the Y-Z plane relatively to the display. The second pivot connects to the base and is able to pivot in the X-Y plane relatively to the base. The pin connects the first pivot and the second pivot and the first pivot is able to pivot in the X-Z plane relatively to the second pivot. The display and the control elements do not overlap each other.

The monitor further includes an access unit located aside the display. The display and the access unit do not overlap each other. The access unit is a floppy disc driver or an optical disc driver.

### BRIEF DESCRIPTION OF THE DRAWINGS

The invention will become more fully understood from the detailed description given hereinbelow. However, this description is for purposes of illustration only, and thus is not limitative of the invention, wherein:

FIG. 1A is an operational view of a conventional pivotal monitor in a horizontal position;

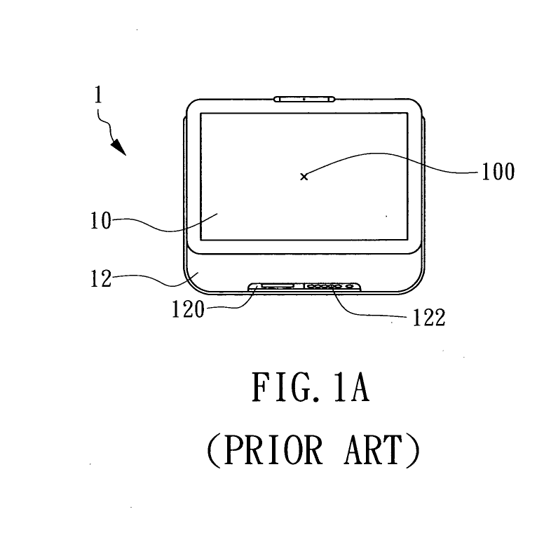

FIG. 1B is an operational view of a conventional pivotal monitor in intermediate rotating positions;

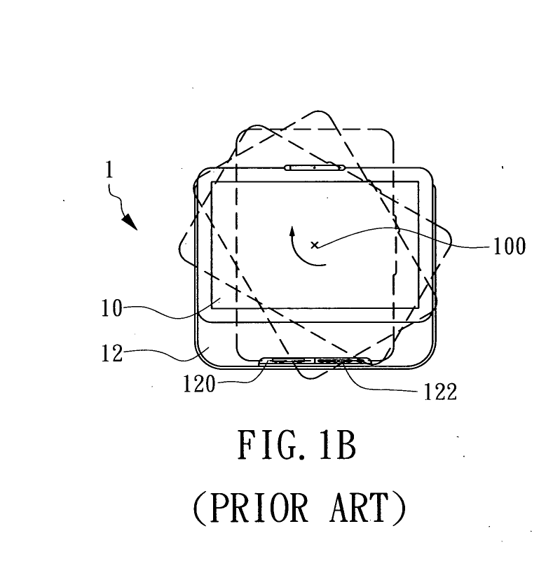

FIG. 1C is an operational view of a conventional pivotal monitor in a vertical position;

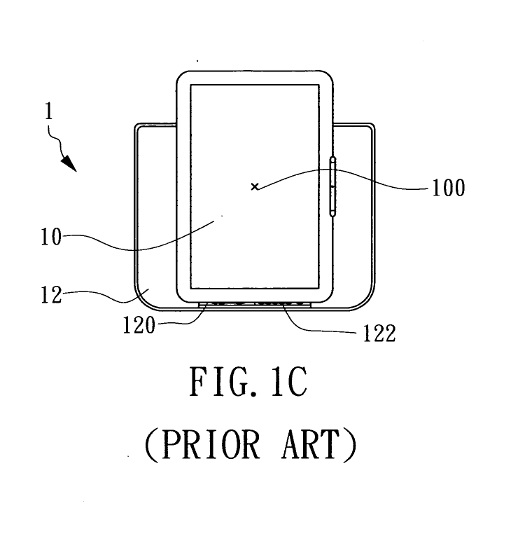

FIG. 2 is a side view and partial enlargement of a monitor as a preferred embodiment of the invention;

FIG. 3A is an operational view of a monitor of the invention in a horizontal position;

FIG. 3B is an operational view of a monitor of the invention in intermediate rotating positions; and

FIG. 3C is an operational view of a monitor of the invention in a vertical position.

### DETAILED DESCRIPTION OF THE INVENTION

The characteristic of the invention is to locate the pivot of a monitor in an eccentric position so that the display in its rotation range will not cover the control elements or access units on a base of the monitor.

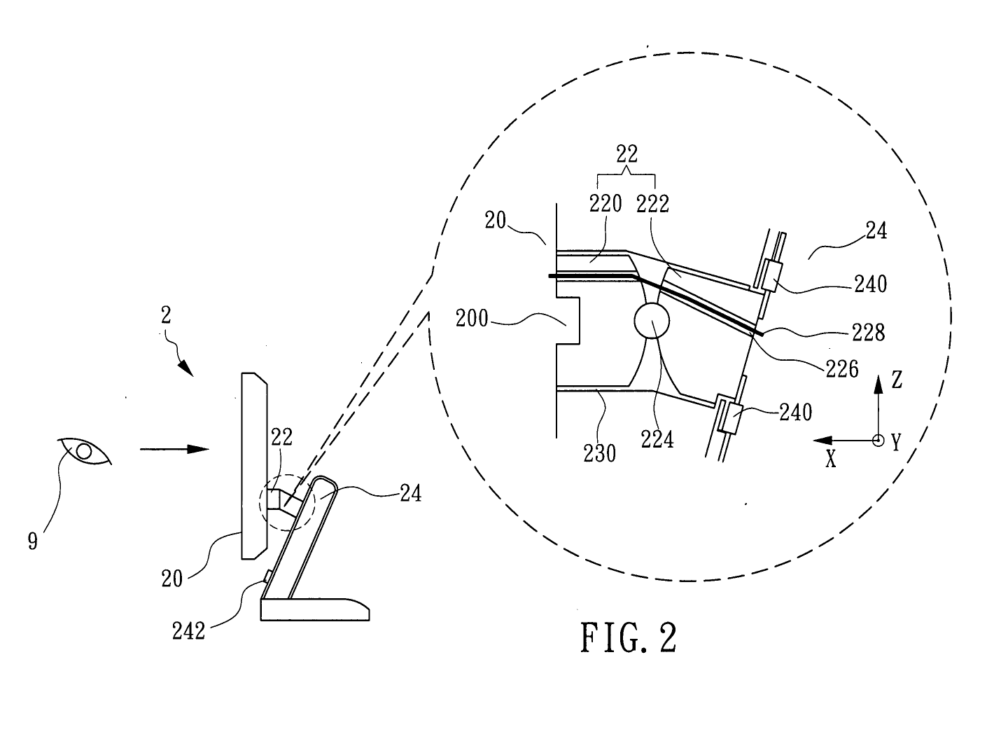

Referring to FIG. 2, a side view and partial enlargement of an embodiment of the invention is shown. A monitor 2 of the invention includes a display 20 for users 9 to view. The display 20 is mainly a rectangular member or of any other suitable shapes. A connecting member 22 connects the display 20 to a base 24. The base 24 includes some control elements 242.

As shown in the partial enlargement, the connecting member 22 connects the display 20 at an eccentric position. In addition, the connecting member 22 has an internal space 226 and a first pivot 220, a second pivot 222 and a pin 224. The first pivot 220 has a pivotal portion 200 connecting to the display 20 for being pivoting in the Y-Z plane relatively to the display 20 (a vertical plane mainly parallel to the plane of the display). The second pivot 222 has another pivotal portion 240 connecting to the base 24 for being pivoting in the X-Y plane relatively to the base 24 (a horizontal plane). The pin 224 connects the first pivot 220 and the second pivot 222, so the first pivot 220 is able to pivot in the X-Z plane relatively to the second pivot 222 (a vertical plane mainly perpendicular to the plane of the display). Therefore, the display 20 can be rotated in many directions relatively to the base 24. The internal space 226 in the connecting member 22 is for enclosing the signal or power wires 228 connecting between the display 20 and the base 24.

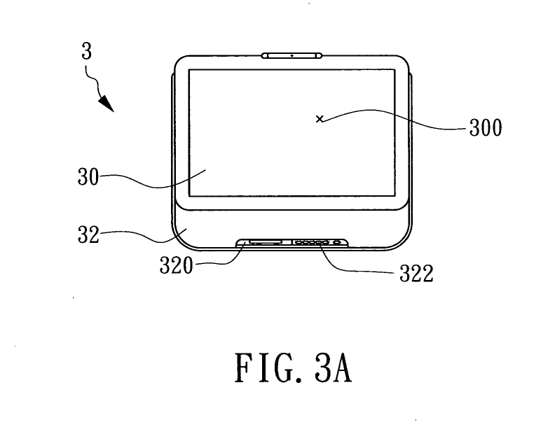

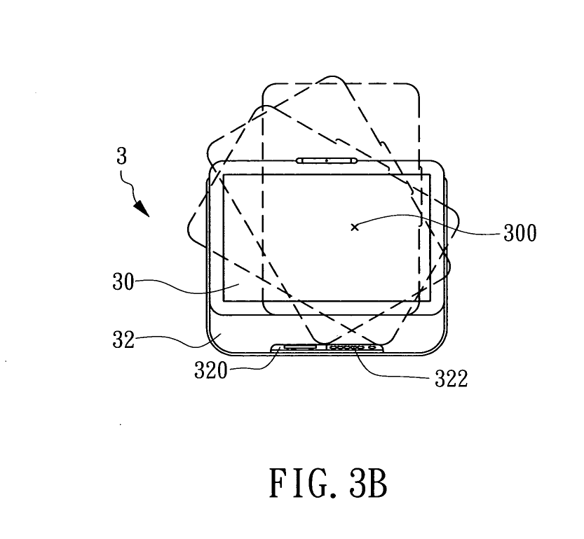

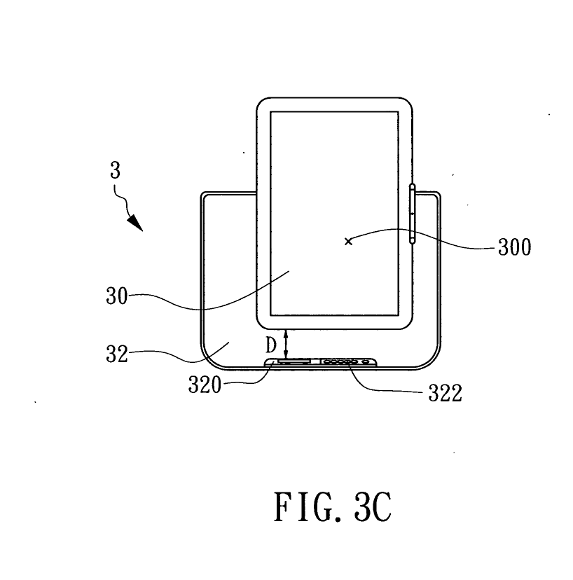

FIGS. 3A, 3B, and 3C are sequential views of rotating a monitor 3 of the invention from a horizontal position to a vertical position. The monitor 3 includes a display 30 and a base 32. The display 30 is pivoted on a point 300 (eccentric from the geometric centers of the display 30 or/and the base 32) for relative rotation to the base 32. The base 32 includes an access unit 320 and some control elements 322. The access unit 320 can be an optical disc driver, a floppy disc driver or the like. The control elements 322 can be buttons for adjusting the display 30, such as color and brightness.

After rotating the display 30 into a vertical position, since the pivotal point 300 is eccentric, the display 30 after rotation keeps a distance D from the access unit 320 and the control elements 322 so that the display 30 does not interfere the user's operations on the access unit 320 and the control elements 322.

As described above, the invention provides an eccentric pivotal connection for a monitor to free from hindering the base after rotation. It overcomes the drawbacks of conventional centric pivots. The base in the invention is not limited to have the access unit or control elements, but other kinds of components, such as USB slots, earphone jackets, speakers and so on, can also be included. The connecting member in the invention can be eccentric to the display only, eccentric to the base only, or eccentric to the both. Anyway, it is just in a suitable position to free the display from hindering the operational elements on the base after rotation.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. A monitor capable of rotating on a pivot, comprising:
a base, mounted thereon at least a control element and an access unit;
a display, pivotally connected to said base, for being rotated to suitable viewing angles; and
a connecting member having an internal space and connecting said display to said base at eccentric positions misaligned from geometrical centers of said display or said base; said connecting member further comprising
a first pivot connecting to said display and being able to pivot in the Y-Z plane relatively to said display;
a second pivot connecting to said base and being able to pivot in the X-Y plane relatively to said base; and
a pin connecting said first pivot and said second pivot and said first pivot being able to pivot in the X-Z plane relatively to said second pivot; said display does not overlap said control element and said access unit on said base.

2. (canceled)

3. A monitor capable of rotating on a pivot according to claim 1 wherein said access unit is a floppy disc driver.

4. A monitor capable of rotating on a pivot according to claim 1 wherein said access unit is an optical disc driver.
